(19) United States
(12) Patent Application Publication
(10) Pub. No.: US 2026/0208130 A1
(43) Pub. Date: Jul. 23, 2026

(54) EXHAUST GAS MIXER WITH ANNULAR ORIFICE

(71) Applicant: Tenneco Automotive Operating Company LLC, Northville, MI (US)

(72) Inventor: Srdjan KUSTRIMOVIC, Edenkoben (DE)

(21) Appl. No.: 19/138,249

(22) PCT Filed: Dec. 13, 2023
(86) PCT No.: PCT/EP2023/085593

§ 371 Date: Jun. 12, 2025

(30) Foreign Application Priority Data
Dec. 13, 2022 (DE) 10 2022 133 091.5

(51) Int. Cl. B01F 25/431

(52) U.S. Cl. CPC B01F 25/4319; B01F 25/43171; B01F 2215/0422; B01F 2215/0427

(57) ABSTRACT

An exhaust gas mixer includes an exhaust pipe for guiding exhaust gas, including a longitudinal axis, and defining a flow cross-sectional area Q1. A mixer element is disposed within the exhaust pipe and has an outer diameter Mb and an outlet having a cross-sectional area QM. A gap is disposed between the exhaust pipe and the mixer element for guiding exhaust gas. An orifice body positioned within the exhaust pipe to direct the exhaust gas exiting the gap in a radial direction. The orifice body includes at least one orifice extending therethrough. The at least one orifice opening comprises a total flow cross-sectional area QB, wherein 0.5 Q1<=QB<=0.9 Q1.

### CROSS-REFERENCE TO RELATED APPLICATIONS

This application is a U.S. National Phase Application under 35 U.S.C. 371 of International Application No. PCT/EP2023/085593, filed on Dec. 13, 2023, which claims priority to German Patent Application No. 10 2022 133 091.5, filed on Dec. 13, 2022. The entire disclosure of the above German application is incorporated herein by reference.

### FIELD

The disclosure relates to an exhaust gas mixer comprising: an exhaust pipe comprising a middle axis and an exhaust pipe wall for guiding exhaust gas, a mixer element placed within the exhaust pipe and having a width or outer diameter Mb and an outlet cross-sectional area QM, wherein the exhaust pipe wall, together with the mixer element, delimits a gap having a width Sb, in which exhaust gas can be guided, wherein an orifice is provided in the exhaust pipe downstream of the mixer element, wherein the orifice comprises an orifice edge being arranged at least indirectly on the exhaust pipe, and at least one orifice opening being enclosed or delimited by the orifice edge, and wherein the exhaust pipe wall delimits a flow cross-sectional area Q1 for exhaust gas. The mixer element can be tubular in shape, wherein several exhaust gas inlet openings and one exhaust gas outlet opening are arranged opposite each other. The exhaust gas inlet openings can create an exhaust gas flow that enters in a radial direction or in a circumferential direction. The exhaust gas outlet opening can produce an exhaust gas flow exiting in the axial direction.

### BACKGROUND

This section provides background information related to the present disclosure which is not necessarily prior art.

The disclosure also relates to an orifice for an exhaust gas mixer comprising a middle axis comprising an orifice edge and an orifice opening delimited by the orifice edge, the orifice spanning a plane.

An exhaust gas mixer with an orifice is already known from US 2011/0061374 A1. The orifice is located downstream of the mixing pipe and has a radially aligned annular shoulder, an adjoining pipe section and a centrally arranged baffle plate, wherein the pipe section and the baffle plate are provided with a perforation.

### SUMMARY

This section provides a general summary of the disclosure, and is not a comprehensive disclosure of its full scope or all of its features.

The disclosure solves the problem of designing and arranging an exhaust gas mixer in such a way that sufficient mixing and an advantageous gas backpressure are achieved.

The problem is solved, according to the disclosure, in that:
a) the at least one orifice comprises a total flow cross-sectional area QB, wherein: 0.5 Q1<=QB<=0.9 Q1, or 0.8 QM<=QB<=1.2 QM, or in that
b) the orifice, downstream of the orifice opening, comprises an orifice wall comprising a perforation comprising a total flow cross-sectional area QW, wherein:

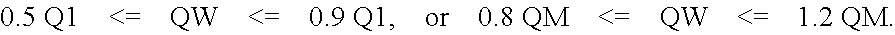

This ensures that sufficient mixing of the exhaust gas is possible despite low gas backpressure. The orifice edge of comprises a projection surface Fr in relation to the middle axis and the at least one orifice opening comprises a projection surface Fo, wherein the flow cross-sectional area Q1 corresponds to the sum of the projection surface Fr and the projection surface Fo. The projection surface is aligned normally or at right angles to the middle axis.

The problem is also solved, according to the disclosure, in that:
a) the orifice edge encloses an angle β, wherein 0°<=β<80°; or
b) the orifice edge comprises a blade structure or a lamella structure comprising several blades or lamellae. In each case, said angle β is the smallest angle between the side of the orifice edge facing the exhaust gas flow or the side of the orifice edge facing away from the exhaust gas flow and the clamped plane, respectively.

It can be advantageous if the orifice edge comprises a perforation comprising a total flow cross-sectional area QR, wherein: 0.1 QB<=QR<=0.2 QB, or 0.1 QW<=QR<=0.2 QW. The perforation on the orifice edge prevents a dead flow downstream of the orifice edge in the area of the exhaust pipe wall.

It can also be advantageous in this context if the orifice edge forms an angle α with the exhaust pipe wall, wherein 70°<=α<90°. By applying an angle α, the deflection of the exhaust gas flow entering through the gap is varied accordingly. The deflection can take place both in the direction of flow and in the opposite direction by applying a corresponding positive angle α or a negative angle α.

Furthermore, it can be advantageous if the orifice edge comprises an axial distance (d) from the mixer element, wherein:

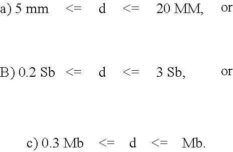

The aforementioned variations in the distance between the orifice edge and the mixer element ensure an optimum inflow of the exhaust gas flow entering through the gap and thus an optimum mixing into the exhaust gas flow entering through the mixer element on the one hand and an optimum mixing of the added additive into the exhaust gas heat flow on the other.

It can also be advantageous if the orifice edge comprises a blade or lamella structure comprising several blades or lamellae. The use of several blades or lamellae distributed around the circumference further improves the mixing of the exhaust gas flow at the edge.

It may advantageously be provided that the respective blade forms an angle α with the exhaust pipe wall, wherein 70°<=α<=90°, with adjacent blades comprising a different angulation. The angulation of the blades provides for similar advantages as the angulation of the orifice edge described above. Further advantages can be associated with the fact that neighboring blades comprise a different angulation, so that the exhaust gas flow on the gap side is only partially deflected in a radial direction. Another part is then also deflected in the opposite direction to the exhaust gas flow.

It can be of particular importance for the present disclosure if at least one blade comprises a central axis which runs at right angles to the middle axis, wherein the at least one blade has a torsion which is achieved by a twisting or pivoting about the central axis. With the use of torsioned blades or lamellae, a circumferential direction of the gap-side exhaust gas flow is achieved during mixing into the central exhaust gas flow. Due to this circumferential component, the mixing of the exhaust gas flow or of the additive is further improved. When twisted, the base and blade end are not aligned equally, whereas when the entire blade is pivoted, the base and blade end are aligned equally.

In connection with the design and arrangement according to the disclosure, it can be advantageous if the torsion of adjacent blades is in the same or opposite direction. The use of oppositely directed torsion of adjacent blades or lamellae prevents the formation of a swirl flow. However, other flow components are created locally in the area of the respective blade pairs or lamellae pairs during the mixing of the gap-side exhaust gas flow, which positively influence the mixing of the additive.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further advantages and details of the disclosure are explained in the patent claims and in the description and shown in the figures. It shows:

FIG. 1 a side view of the exhaust gas mixer;

FIG. 2 a side view of the end section of the mixer;

FIG. 2a a representation of the projection surfaces;

FIG. 3 a side view of an end section of the mixer;

FIG. 3a a representation of the total flow cross-sections;

FIG. 4 a front view of an orifice;

FIG. 5a a side view of an alternative embodiment;

FIG. 5b a side view of an alternative embodiment;

FIG. 5c a side view of an alternative embodiment;

FIG. 6 a front view of an orifice;

FIG. 7 a side view of an orifice.

### DETAILED DESCRIPTION

Example embodiments will now be described more fully with reference to the accompanying drawings.

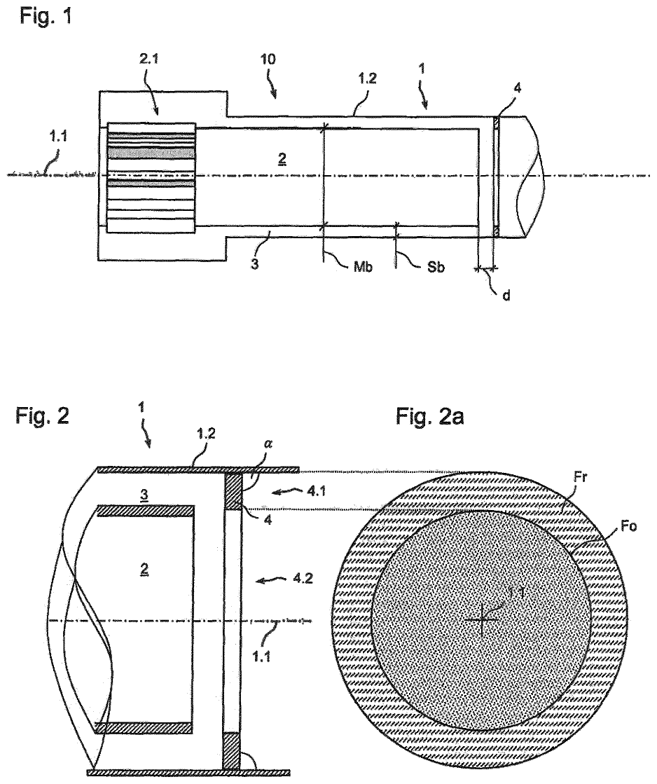

The figures described herein below basically relate to schematic diagrams. A mixer 10 shown in FIG. 1 comprises an exhaust pipe 1 comprising a middle axis 1.1, inside which a mixer element 2 is mounted. The mixer element 2 comprises a blade zone 2.1, into which the exhaust gas to be provided with additive flows into the mixer element 2. Further, a gap 3 is provided between the mixer element 2 and the exhaust pipe 1, in which part of the exhaust gas flow that does not enter the mixer element 2 via the blade zone 2.1 is guided. An orifice body 4 comprising a middle axis 4.5 is provided downstream of the mixer element 2, the orifice body 4 being fixed in the exhaust pipe 1 or on the exhaust pipe wall 1.2. The mixer element 2 has a diameter or width Mb. The gap has a width Sb. The orifice body 4 has a distance d to the downstream end of the mixer element 2.

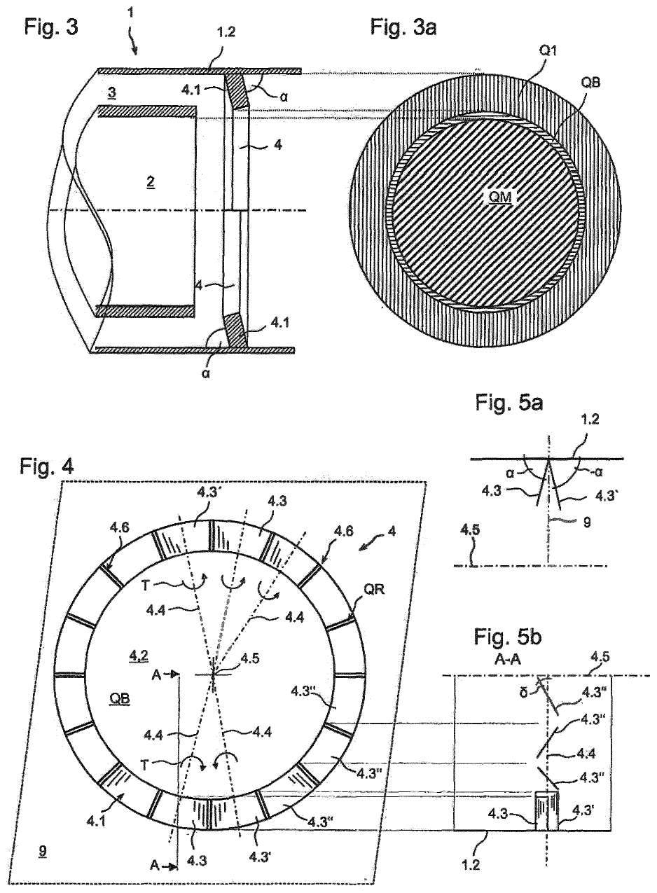

According to the embodiment of FIG. 2, the orifice body 4 is designed as an annular orifice. The orifice body 4 comprises an orifice edge 4.1 and an orifice opening 4.2, which is designed as a recess according to FIG. 2. As already mentioned, the orifice edge 4.1 is designed as an annular orifice (plate). It encloses an angle α of 90° together with the exhaust pipe wall 1.2. This results in the projection surfaces Fr, Fo shown in FIG. 2a for the orifice edge 4.1 and the orifice opening 4.2. The projection surface Fo corresponds to a total flow cross-sectional area QB of the orifice opening 4.2, as shown in FIG. 3a.

According to the embodiment of FIG. 3, upper half of the figure, the orifice edge 4.1 of the orifice body 4 facing away from the exhaust gas is angled further in relation to the exhaust pipe wall 1.2 and defines a smallest angle α of less than 90°, in this case approximately 76°. According to the alternative embodiments of FIG. 3, lower half of the figure, the orifice edge 4.1 facing the exhaust gas is angled in the opposite direction to the exhaust gas flow. The smallest (blade) angle α is the same. According to the embodiment of FIG. 3a, the total flow cross-sectional area Q1 of the exhaust pipe 1.2 is shown and also, as a partial area thereof, the total flow cross-sectional area QB of the orifice opening 4.2 and, as a further partial area thereof, the total flow cross-sectional area QM of the mixer element 2. The orifice edge 4.1 of the orifice body 4 is free of perforations or without exhaust gas openings 4.6.

According to the embodiment of FIG. 4, the orifice body 4 comprises an orifice edge 4.1, which is designed as a blade structure comprising several blades 4.3, 4.3′. The respective blades 4.3, 4.3′ are twisted about a radial central axis 4.4 and comprise a corresponding torsion T with respect to the central axis 4.4. In the upper half of FIG. 4, adjacent blades 4.3, 4.3′ are provided with the same torsion, while in an alternative embodiment according to FIG. 4, lower half of the figure, adjacent blades 4.3, 4.3′ comprise an opposite torsion T. The respective torsion T of the blades 4.3 creates exhaust gas passage openings 4.6 so that exhaust gas can pass through the orifice edge 4.1. The orifice opening 4.2 is again open or designed as a recess with a corresponding total flow cross-sectional area QB. The orifice body 4 is positioned within a plane 9.

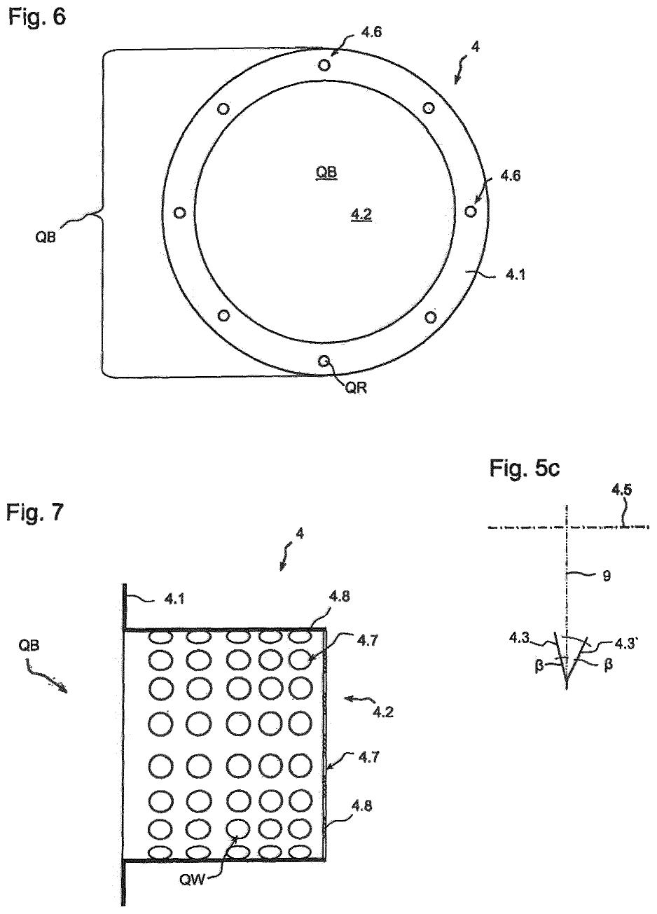

According to the embodiment of FIG. 5a, adjacent blades 4.3, 4.3′ are angled in opposite directions and each enclose a minimum angle α with the exhaust pipe wall 1.2. Here, the two embodiments shown in FIG. 3 are combined to form the angle α, so to speak. The blade 4.3 has an angle α of approx. 75° and the blade 4.3′ has an angle α of approx. −75°, in each case measured counterclockwise from the exhaust pipe wall 1.2.

According to FIG. 5b, a side view A-A of the lower blades 4.3, 4.3′ from FIG. 4 is sketched, and the other three blades 4.3″ up to the middle axis 4.5 are depicted in a conventionalized manner. The blades 4.3, 4.3′ comprise an opposite torsion T having a torsion angle δ. The torsion angle δ is approx. 45°.

The embodiment of FIG. 5c shows the orifice body 4 alone without the exhaust pipe wall. Neighboring blades 4.3, 4.3′ are also angled in opposite directions. In contrast to FIG. 5a, however, this also applies to the modulus. Blade 4.3 has an angle β of approx. 15° and blade 4.3′ has an angle β of approx. −25°, both measured counterclockwise from plane 9.

According to the embodiment of FIG. 6, the orifice edge 4.1 of the orifice body 4 comprises a perforation 4.6 having a total flow cross-sectional area QR that is significantly smaller than the total flow cross-sectional area QB of the orifice opening 4.2.

According to the embodiment of FIG. 7, the orifice body 4 comprises an orifice wall 4.8 that extends downstream of the orifice opening 4.2. The orifice wall 4.8 comprises a perforation 4.7 having a total flow cross-sectional area QW. The total flow cross-sectional area QW corresponds approximately to the total flow cross-sectional area QB of the orifice body 4. Thus, the orifice edge 4.1 produces the same mixing effect as in the embodiments of FIGS. 2 and 3 without the orifice wall 4.8. In contrast to the embodiment of FIG. 2, the orifice wall 4.8 fulfills an additional mixing function due to the perforation 4.7. The exhaust gas is additionally swirled due to the perforation 4.7. Pressure losses can be counteracted by using a correspondingly large total flow cross-sectional area QW.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or de-scribed. The same may also be varied in many ways. Such variations are to be re-garded as a departure from the disclosure, and all such modifications are intended to be included within the scope of the disclosure.

1-11. (canceled)

12. An exhaust gas mixer, comprising:
an exhaust pipe for guiding exhaust gas, including a longitudinal axis, and defining a flow cross-sectional area Q1;
a mixer element disposed within the exhaust pipe and having an outer diameter Mb and an outlet having a cross-sectional area QM;
a gap disposed between the exhaust pipe and the mixer element for guiding exhaust gas; and
an orifice body positioned in the exhaust pipe to direct the exhaust gas exiting the gap in a radial direction, the orifice body including at least one orifice opening extending therethrough, the at least one orifice opening comprising a total flow cross-sectional area QB, wherein 0.5 Q1<=QB<=0.9 Q1.

13. The exhaust gas mixer according to claim 12, wherein

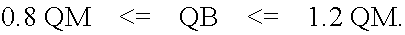

14. The exhaust gas mixer according to claim 12, wherein
the orifice body comprises a perforation comprising a total flow cross-sectional area QR, wherein:

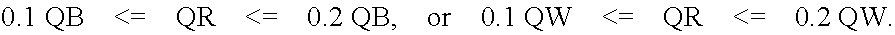

15. The exhaust gas mixer according to claim 12, wherein
the orifice body is shaped as a plate and forms an angle α with a wall of the exhaust pipe, wherein 70°<=α<90°.

16. The exhaust gas mixer according to claim 12, wherein
the orifice body is spaced an axial distance d from the mixer element, the gap having a width Sb, wherein

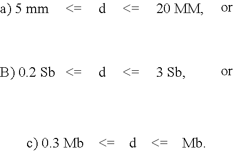

17. The exhaust gas mixer according to claim 12, wherein
the orifice body comprises a blade structure or a lamella structure including a plurality of blades or lamellae.

18. The exhaust gas mixer according to claim 17, wherein
one of the plurality of blades encloses an angle α with a wall of the exhaust pipe wall, wherein 70°<=α<=90°,
wherein adjacent blades comprise a different angulation.

19. The exhaust gas mixer according to claim 17, wherein
the one of the plurality of blades includes a central axis which extends at a right angle to a longitudinal axis of the exhaust pipe, the one of the plurality of blades includes having a helix which is achieved by a rotation or pivoting about the central axis.

20. The exhaust gas mixer according to claim 19, wherein
adjacent blades include a helix in the same or an opposite direction as the helix of the one of the plurality of blades.

21. The exhaust gas mixer according to claim 12, wherein the orifice body is positioned downstream of the mixer element to direct the exhaust gas exiting the gap radially inwardly at a position downstream of the outlet of the mixer element.

22. An exhaust gas mixer, comprising:
an exhaust pipe for guiding exhaust gas, including a longitudinal axis, and defining a flow cross-sectional area Q1;
a mixer element disposed within the exhaust pipe and having an outer diameter Mb and an outlet having a cross-sectional area QM;
a gap disposed between the exhaust pipe and the mixer element for guiding exhaust gas; and
an orifice body positioned in the exhaust pipe to direct the exhaust gas exiting the gap in a radial direction, the orifice body including at least one orifice opening extending therethrough, the at least one orifice opening comprising a total flow cross-sectional area QB, wherein 0.8 QM<=QB<=1.2 QM.

23. The exhaust gas mixer according to claim 22, wherein 0.5 Q1<=QB<=0.9 Q1.

24. An exhaust gas mixer, comprising:
an exhaust pipe for guiding exhaust gas, including a longitudinal axis, and defining a flow cross-sectional area Q1;
a mixer element disposed within the exhaust pipe and having an outer diameter Mb and an outlet having a cross-sectional area QM;
a gap disposed between the exhaust pipe and the mixer element for guiding exhaust gas; and
an orifice body positioned in the exhaust pipe to direct the exhaust gas exiting the gap in a radial direction, the orifice body including at least one orifice opening extending therethrough, the at least one orifice opening comprising a total flow cross-sectional area QB, wherein
the orifice body comprises an orifice wall including at least one perforation comprising a total flow cross-sectional area QW, wherein: 0.5 Q1<=QW<=0.9 Q1, or 0.8 QM<=QW<=1.2 QM.

25. The exhaust gas mixer according to claim 24, wherein
the orifice body is spaced an axial distance d from the mixer element, the gap having a width Sb, wherein

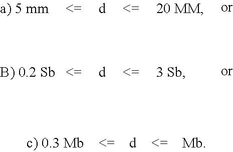

26. The exhaust gas mixer according to claim 24, wherein the orifice body is positioned in the exhaust pipe downstream of the mixer element to direct the exhaust gas exiting the gap radially inwardly at a position downstream of the outlet of the mixer element.
